(19) United States
(12) Patent Application Publication
(10) Pub. No.: US 2021/0078105 A1
(43) Pub. Date: Mar. 18, 2021

(54) LAP WELDING WITH DESIGNED GAP FOR INCREASED JOINT STRENGHT

(71) Applicant: Magna Seating Inc, Aurora (CA)

(72) Inventors: Alan Cárdenas Vásquez, Saltillo (MX); Francisco Cepeda Rodríguez, Saltillo (MX); Jorge Enrique López Quiroga, Saltillo (MX); Israel Lacombe, Swartz Creek (CA)

(21) Appl. No.: 17/049,986

(22) PCT Filed: Apr. 23, 2019
(86) PCT No.: PCT/CA2019/050508

§ 371 Date: Oct. 23, 2020

Related U.S. Application Data
(60) Provisional application No. 62/661,343, filed on Apr. 23, 2018.

(51) Int. Cl. B23K 26/244; B60N 2/68

(52) U.S. Cl. CPC B23K 26/244; B60N 2/682

(57) ABSTRACT

A method of welding a first piece to a second piece by laser welding is disclosed. The first piece includes a central portion between two outer portions. The method comprises the step of placing the first piece adjacent the second piece, where the central portion of the first piece is a distance from the second piece, and the outer portions of the first piece are flush with the second piece. The method also comprises the step of applying a laser beam to the central portion toward the second piece. Material from the first piece combines with material from the second piece to form a welded material. A shear section of the welded material extends between the first and second pieces. A width of the shear section is greater than a width of the welded material in the first piece.

### CROSS-REFERENCE TO RELATED APPLICATIONS

This application claims priority to U.S. provisional patent application No. 62/661,343, filed Apr. 23, 2018, which is incorporated herein by reference.

### TECHNICAL FIELD

The present invention relates to an improved welding method that increases the strength/shear torque of the weld while decreasing the cycle time and heat input of the welding process.

### BACKGROUND OF THE INVENTION

The automotive industry continually strives to improve safety while concurrently pursuing weight reduction. For example, the automotive industry has been reducing the size of disc recliners by using smaller components with tighter tolerances. The disc recliners must maintain smooth effort performance and strength (torque output) for safety regulations.

FIG. 1 illustrates a typical welding application for a disc recliner 10 using a single 350-degree weld 12. FIG. 2 is a cross-sectional view of the disc recliner 10 cut along line A-A of FIG. 1 illustrating the layout of two pieces 14, 16 from the disc recliner 10 before they are welded together. As depicted in FIG. 2, the first piece 14 is flush against the second piece 16. A laser beam 18 is applied to the first piece 14 toward the second piece 16 to form a welded material 20. A shear section 22 of the welded material 20 extends between the first and second pieces 14, 16. The width of the welded material 20, and hence the width of shear section 22, is relatively consistent as the welded material 20 propagates from first piece 14 to second piece 16. The width of shear section 22 directly affects the strength/shear torque of the weld. To increase the strength of the weld in typical welding applications, more heat and cycle time is added to the weld to increase the fluid flow of the welded material 20 and thereby increase the width of shear section 22.

There is a need to develop a new laser welding method that increases the strength/shear torque of the weld while reducing the cycle time and heat input of the welding process.

### SUMMARY OF THE INVENTION

According to one embodiment, there is provided a method of welding a first piece to a second piece. The first piece includes a central portion between two outer portions. The method comprises the step of placing the first piece adjacent the second piece, where the central portion of the first piece is a distance from the second piece, and the outer portions of the first piece are flush with the second piece. The method also comprises the step of applying a laser beam to the central portion toward the second piece. Material from the first piece combines with material from the second piece to form a welded material. A shear section of the welded material extends between the first and second pieces. A width of the shear section is greater than a width of the welded material in the first piece.

According to another embodiment, there is provided a method of welding a first piece to a second piece. The method comprises the steps of placing the first piece a distance from the second piece and applying a laser beam to the first piece toward the second piece. Material from the first piece combines with material from the second piece to form a welded material. A shear section of the welded material extends between the first and second pieces. A width of the shear section is greater than a width of the welded material in the first piece.

According to another embodiment, there is provided a method of welding a first piece to a second piece. The method comprises the step of placing the first piece adjacent the second piece, where a first portion of the first piece is a distance from the second piece, and a second portion of the first piece is flush against the second piece. The method also comprises the step of applying a laser beam to the first portion toward the second piece. Material from the first piece combines with material from the second piece to form a welded material. A shear section of the welded material extends between the first and second pieces. A width of the shear section is greater than a width of the welded material in the first piece.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a side view of a disc recliner showing a typical welding application in accordance with the prior art;

FIG. 2 is a cross-sectional view of a portion of the disc recliner cut along line A-A of FIG. 1 illustrating the layout of two pieces before they are welded together;

FIG. 3 is a cross-sectional view of the portion of the disc recliner of FIG. 2 after the two pieces are welded together;

FIG. 4 is a side view of a disc recliner showing a welding application in accordance with one embodiment of the present invention;

FIG. 5 is a cross-sectional view of a portion of the disc recliner cut along line B-B of FIG. 4 illustrating the layout of two pieces according to one embodiment before they are welded together;

FIG. 6 is a cross-sectional view of the portion of the disc recliner of FIG. 5 after the two pieces are welded together;

FIG. 7 is a cross-sectional view illustrating the layout of two pieces according to another embodiment before they are welded together in accordance with the present invention;

FIG. 8 is a cross-sectional view of the two pieces of FIG. 7 after they are welded together;

FIG. 9 is a cross-sectional view illustrating the layout of two pieces according to yet another embodiment before they are welded together in accordance with the present invention; and

FIG. 10 is a cross-sectional view of the two pieces of FIG. 9 after they are welded together.

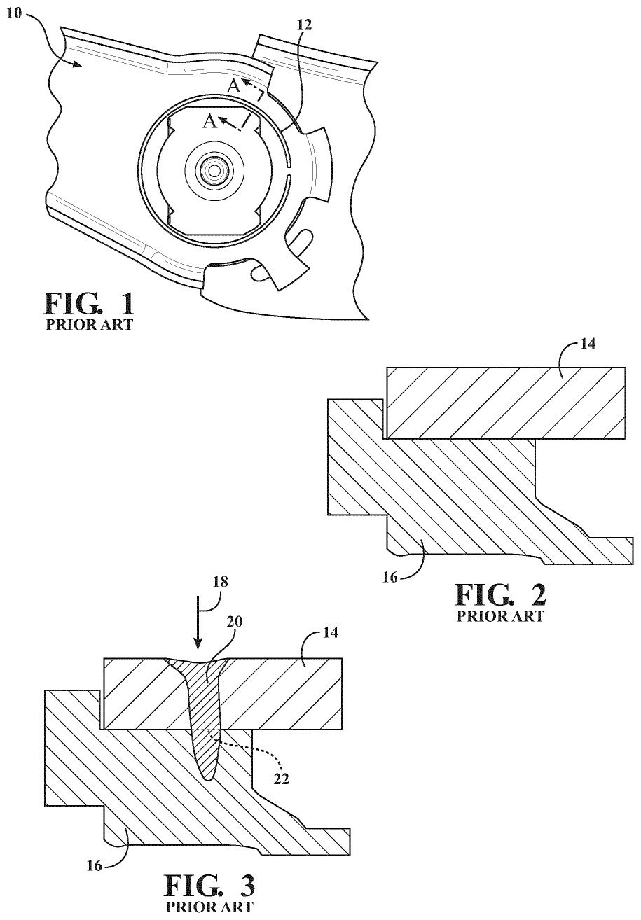

### DETAILED DESCRIPTION OF EXAMPLE EMBODIMENTS

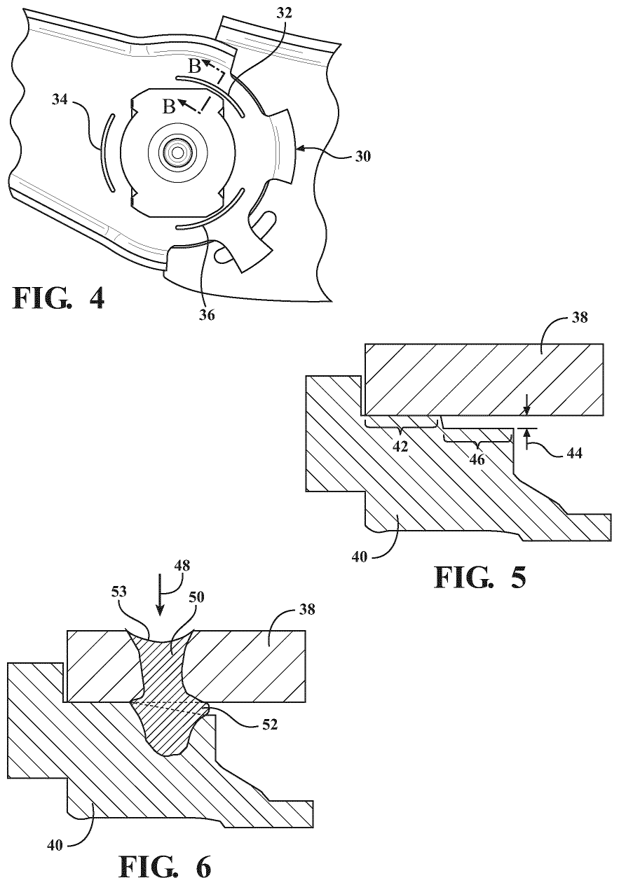

FIG. 4 illustrates a welding application for a disc recliner 30 in accordance with the present invention. Because the present invention increases the strength of the weld, the weld length may be reduced to three welds 32, 34 and 36 (e.g., three 58.5-degree welds) equally spaced apart rather than using a single 350-degree weld. Although described for use on a disc recliner in an automotive vehicle, the welding method in accordance with the present invention may be used for other applications and in other industries, without varying from the scope of the invention.

FIG. 5 is a cross-sectional view of the disc recliner 30 cut along line B-B of FIG. 4 illustrating the layout of two pieces 38, 40 from the disc recliner 30 before they are welded together. The first piece 38 is flush against a first portion 42 of the second piece 40, and the first piece 38 is a distance 44 away from a second portion 46 of the second piece 40 defining a weld gap therebetween. The second piece 40 may be formed by stamping a sheet of metal into the desired configuration. Alternatively, other methods known in the art, such as casting or fineblanking, may be used to obtain the desired configuration. As depicted in FIG. 6, a laser beam 48 is applied to the first piece 38 toward the second piece 40 to form a welded material 50. The weld material 50 forms a shear section 52 extending between the first and second pieces 38, 40 and filling at least a portion of the weld gap 44. The width of the shear section 52 is greater than the width of the welded material 50 in the first piece 38 and the width of the welded material 50 in the second piece 40. Since the width of shear section 52 is greater, the strength/shear torque of the weld is increased. As a result of fluid flow of welded material 50, there may be some concavity 53 formed and remaining in the upper surface of first piece 38.

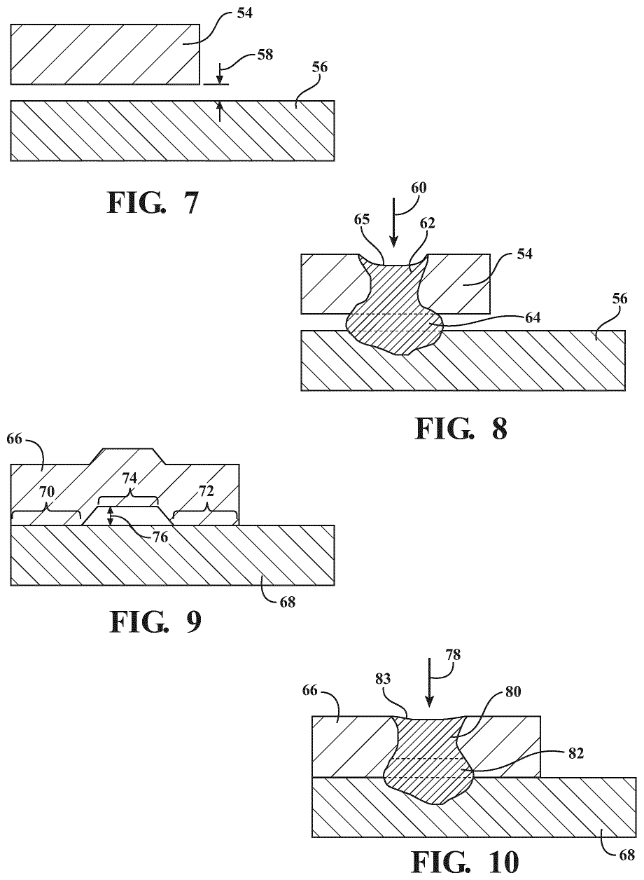

FIG. 7 illustrates another embodiment of the layout of a first piece of material 54 adjacent a second piece of material 56 before they are welded together. In this embodiment, the first piece 54 is positioned a distance 58 from the second piece 56 defining a weld gap therebetween. As depicted in FIG. 8, laser beam 60 is applied to the first piece 54 toward the second piece 56 to form a welded material 62. A shear section 64 of the welded material 62 extends between the first and second pieces 54, 56 and filling at least a portion of the weld gap 58 therebetween. The width of the shear section 64 is greater than the width of the welded material 62 in the first piece 54 and the width of the welded material 62 in the second piece 56. Since the width of shear section 64 is greater, the strength/shear torque of the weld is increased. As a result of fluid flow of welded material 62, there may be some concavity 65 formed and remaining in the upper surface of first piece 54.

FIG. 9 illustrates another embodiment of the layout of a first piece of material 66 adjacent a second piece of material 68 before they are welded together. In this embodiment, a first outer portion 70 of the first piece 66 and a second outer portion 72 of the first piece 66 are flush against the second piece 68, while a recessed central portion 74 formed in the bottom surface of the first piece 66 is positioned a distance 76 from the second piece 68 defining a weld gap therebetween. The first piece 66 further includes a raised central portion 75 formed in the upper surface of the first piece 66 opposite, spaced above, and generally symmetrical in shape to the recessed central portion 74 formed in the bottom surface of the first piece 66. The first piece 66 may be formed by stamping a sheet of metal into the desired configuration. Alternatively, other methods known in the art, such as casting or fineblanking, may be used to obtain the desired configuration. As depicted in FIG. 10, a laser beam 78 is applied to the first piece 66 toward the second piece 68 to form a welded material 80. A shear section 82 of the welded material 80 extends between the first and second pieces 66, 68 and fills at least a portion of the weld gap 76 therebetween. The width of the shear section 82 is greater than the width of the welded material 80 in the first piece 66 and the width of the welded material 80 in the second piece 68. Since the width of shear section 82 is greater, the strength/shear torque of the weld is increased. Since the upper surface of first piece 66 is locally raised at the raised central portion 75 prior to welding, the concavity 83 formed and remaining in the upper surface of first piece 66 from the flow of weld material 80 is substantially reduced or eliminated, thus forming a more uniform, smooth and higher quality surface to the first piece 66.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

1. A method of welding a first piece to a second piece, wherein the first piece includes a central portion between two outer portions, the method comprising the steps of:
placing the first piece adjacent the second piece, wherein the central portion of the first piece is a distance from the second piece, and wherein the outer portions of the first piece are flush with the second piece; and
applying a laser beam to the central portion toward the second piece, wherein material from the first piece combines with material from the second piece to form a welded material, wherein a shear section of the welded material extends between the first and second pieces, and wherein a width of the shear section is greater than a width of the welded material in the first piece.

2. The method of claim 1 wherein the width of the shear section is greater than a width of the welded material in the second piece.

3. The method of claim 1 further comprising the step of stamping or fineblanking a sheet of metal to form the first piece.

4. A method of welding a first piece to a second piece comprising the steps of:
placing the first piece a distance from the second piece; and
applying a laser beam to the first piece toward the second piece, wherein material from the first piece combines with material from the second piece to form a welded material, wherein a shear section of the welded material extends between the first and second pieces, and wherein a width of the shear section is greater than a width of the welded material in the first piece.

5. The method of claim 4 wherein the width of the shear section is greater than a width of the welded material in the second piece.

6. A method of welding a first piece to a second piece comprising the steps of:
placing the first piece adjacent the second piece, wherein a first portion of the second piece is flush against the first piece, and wherein a second portion of the second piece is a distance from the first piece; and
applying a laser beam to the first piece toward the second portion of the second piece, wherein material from the first piece combines with material from the second piece to form a welded material, wherein a shear section of the welded material extends between the first and second pieces, and wherein a width of the shear section is greater than a width of the welded material in the first piece.

7. The method of claim 6 wherein the width of the shear section is greater than a width of the welded material in the second piece.

8. The method of claim 6 further comprising the step of stamping or fineblanking a sheet of metal to form the second piece.
